(19) United States
(12) Patent Application Publication
(10) Pub. No.: US 2006/0066704 A1
(43) Pub. Date: Mar. 30, 2006

(54) Image forming apparatus

(75) Inventor: Isao Nishida, Ashigara-Kami-Gun (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minami-Ashigara-shi (JP)

(21) Appl. No.: 11/235,721

(22) Filed: Sep. 27, 2005

(30) Foreign Application Priority Data
Sep. 28, 2004 (JP) 2004-282644

(51) Int. Cl. B41J 2/01

(52) U.S. Cl. 347/103

(57) ABSTRACT

The image forming apparatus comprises: an ejection head which ejects droplets of a radiation curing liquid; an intermediate transfer medium on which an image is formed by the droplets ejected from the ejection head; an evaporation device which evaporates the droplets deposited on the intermediate transfer medium; a preliminary curing device which emits radiation onto the droplets deposited on the intermediate transfer medium in order to semi-cure the droplets so that the droplets do not blend with each other; and a transfer device which presses a recording medium against the intermediate transfer medium so that the image formed on the intermediate transfer medium is transferred onto the recording medium, wherein: the droplets deposited on the intermediate transfer medium are evaporated by the evaporation device; and the evaporated droplets are semi-cured by the radiation emitted from the preliminary curing device, and then the image formed on the intermediate transfer medium is transferred onto the recording medium by the transfer device.

### BACKGROUND OF THE INVENTION

1. Field of the Invention

The present invention relates to an image forming apparatus, and more particularly to an image forming apparatus which transfers an image formed by depositing liquid droplets onto an intermediate transfer medium, onto a recording medium.

2. Description of the Related Art

An inkjet recording apparatus (inkjet printer) having an inkjet head (ink ejection head) in which a large number of nozzles are arranged is known as a conventional image forming apparatus. This inkjet recording apparatus forms an image by ejecting ink from the nozzles in the form of liquid droplets while moving the inkjet head relative to the recording medium so that the liquid droplets form dots on a recording medium.

Conventionally, various methods of discharging the ink for such an inkjet recording apparatus are known. For example, the inkjet recording apparatus is known as a method of a piezoelectric system in which a diaphragm constituting a part of a pressure chamber (ink chamber) is deformed by the deformation of a piezoelectric element (piezoelectric actuator) to vary the capacity of the pressure chamber, ink is introduced into the pressure chamber through an ink supply channel during the capacity increase of the pressure chamber, and the ink in the pressure chamber is discharged as droplets from a nozzle when the capacity of the pressure chamber decreases. Moreover, the inkjet recording apparatus is also known as a method of a thermal inkjet system in which the ink is heated to create air bubbles and is discharged by the energy of expansion when the air bubbles increase in size.

In this type of inkjet recording apparatus, a single image is realized by combining the dots which are formed by the ink ejected through the nozzles. With the popularization of digital cameras and the like in recent years, inkjet recording apparatuses are now used widely for printing digital images, and hence inkjet recording apparatuses are required to form highly detailed images on a par with photographic prints.

In order to form a highly detailed image, the dots deposited onto the recording medium may be reduced in size and increased in density so that the number of pixels per image is increased. Therefore, high image quality can be realized.

However, in a conventional inkjet recording apparatus, it is necessary to use low-viscosity ink due to the limited performance of the inkjet head which ejects the ink. Therefore, high-viscosity ink such as that used in offset printing cannot be used. Since this low-viscosity ink contains a large amount of ink solvent, concentration of the ink is low. Then, since the ink solute penetrates into the interior of the recording medium, the concentration of the ink is further reduced on the recording medium surface. Consequently, there is a problem that the image quality decreases on the high-concentration parts of the image. In addition, there is also a problem that solvent processing, which had become unnecessary, must be performed on the recording medium.

Furthermore, even when an attempt is made to reduce the size of the dots which land on the recording medium, there are limits to the extent to which the size of the ink droplets ejected through the nozzles can be reduced. When dots are formed at high density on the recording medium by the ink droplets, adjacent or overlapping dots on the recording medium may run into each other, and color blending may occur. Such running and color blending lead to a decrease in the image quality.

Various devices for forming such a high-quality image while preventing running and color blending of the ink have been proposed in the prior art. For example, it is suggested that an ink is ejected from a recording head onto an intermediate transfer medium; the liquid droplet size is reduced by evaporating the ink solvent on the intermediate transfer medium through heating or the like; the ink droplets are dried to an extent at which running does not occur; and then the ink droplets are transferred onto a recording medium.

As a known example of using this type of intermediate transfer medium, it is known that ink droplets are ejected from an inkjet head and adhered to an intermediate carrier, the diameter of the adhered ink droplets is reduced by evaporating the ink droplets using an evaporation and condensation device such as a heater, and then the ink droplets are pressed against and transferred onto a recording medium (see Japanese Patent Application Publication No. 62-92849, for example).

As another known example, it is known that preliminary recording is performed by ejecting ink from an inkjet head onto the surface of an intermediate recording medium having water repellency, the coloring material concentration of the ink is raised by evaporating the moisture in the ink using a dryer, and then the ink is transferred onto a recording medium such as plain paper. In particular, when printing a full-color print, color running is prevented by performing the ejection and evaporation operations repeatedly for each color, and then performing transfer onto the plain paper (see Japanese Patent Application Publication No. 3-284948, for example).

However, in a conventional inkjet recording apparatus as an image forming apparatus, ink containing a large amount of ink solvent causes the recording paper to swell, causes the ink concentration on the recording paper to decrease, and causes a so-called relief form having an increased image height to create by the ink hardening in an uneven form on the recording paper. Consequently, there is a problem that the image quality may be reduced.

In Japanese Patent Application Publication Nos. 62-92849 and 3-284948 described above, the problems are alleviated to a certain extent. However, further improvement is desirable.

### SUMMARY OF THE INVENTION

The present invention has been designed in consideration of these circumstances, and it is an object thereof to provide an image forming apparatus which can resolve the aforementioned problems of the prior art, and in particular can form a high-quality image by preventing running between liquid droplet dots of various colors formed on a recording medium while reducing the relief effect of an image by reducing the thickness of the image formed by the liquid droplet dots.

In order to attain the aforementioned object, the present invention is directed to an image forming apparatus comprising: an ejection head which ejects droplets of a radiation curing liquid; an intermediate transfer medium on which an image is formed by the droplets ejected from the ejection head; an evaporation device which evaporates the droplets deposited on the intermediate transfer medium; a preliminary curing device which emits radiation onto the droplets deposited on the intermediate transfer medium in order to semi-cure the droplets so that the droplets do not blend with each other; and a transfer device which presses a recording medium against the intermediate transfer medium so that the image formed on the intermediate transfer medium is transferred onto the recording medium, wherein: the droplets deposited on the intermediate transfer medium are evaporated by the evaporation device; and the evaporated droplets are semi-cured by the radiation emitted from the preliminary curing device, and then the image formed on the intermediate transfer medium is transferred onto the recording medium by the transfer device.

According to the present invention, the amount of solvent in the liquid droplet can reduce by evaporating the liquid droplet. Hence, when the image is finally transferred and formed on the recording medium, the color material concentration can be increased while being able to reduce swelling of the recording medium caused by the liquid droplet solvent. Furthermore, since the dot size can be reduced by decreasing the size of the liquid droplet, a thin image formation layer with a reduced relief effect can be obtained, thereby improving the image quality. Moreover, since the liquid droplets are semi-cured through radiation emission so that droplets are not intermixed, running among the colors (color blending) can be prevented even when forming a color image, and then running of the liquid droplets can be suppressed even when plain paper is used as the recording medium.

In order to attain the aforementioned object, the present invention is directed to an image forming apparatus comprising: a plurality of ejection heads which respectively eject droplets of a plurality of radiation curing liquids corresponding to a plurality of colors; an intermediate transfer medium on which an image is formed by the droplets ejected from the ejection heads; an evaporation device which evaporates the droplets deposited on the intermediate transfer medium; a plurality of preliminary curing devices which respectively emit radiation onto the droplets of the colors deposited on the intermediate transfer medium in order to semi-cure the droplets so that the droplets of the colors do not blend with each other; and a transfer device which presses a recording medium against the intermediate transfer medium so that the image formed on the intermediate transfer medium is transferred onto the recording medium, wherein: the intermediate transfer medium is at least one of a rotary drum and an endless belt; the ejection heads are provided for the colors in a movement direction of the intermediate transfer medium; each of the preliminary curing devices is disposed on a downstream side of each of the ejection heads in the movement direction of the intermediate transfer medium; the droplets deposited on the intermediate transfer medium are evaporated by the evaporation device, and then are semi-cured by the radiation emitted from the preliminary curing devices; and the radiation curing liquids of the colors are deposited onto the intermediate transfer medium so as to form the image on the intermediate transfer medium during one rotation of the intermediate transfer medium, and then the image formed on the intermediate transfer medium is transferred onto the recording medium so as to form the image on the recording medium.

The present invention is also directed to the image forming apparatus wherein: the radiation curing liquids of the colors are cured by the radiation in different wavelength regions; and each of the preliminary curing devices emits the radiation in each of the wavelength regions which cure each of the radiation curing liquids ejected from each of the ejection heads.

The present invention is also directed to the image forming apparatus wherein: a solvent amount in the radiation curing liquid of the color ejected first is set to be larger than the solvent amount in the liquids of the colors that are ejected subsequently if the image is formed with the droplets of the colors having a same diameter.

The present invention is also directed to the image forming apparatus wherein: the radiation curing liquids of the colors have different levels of sensitivity to the radiation from each other; and the ejection heads are arranged in the movement direction of the intermediate transfer medium in rising order of the levels of sensitivity of the radiation curing liquids ejected from the ejection heads.

According to present invention, the degree to which the liquid droplets of each color are semi-cured during the formation of a color image can be made even, and color blending among the colors can be prevented.

In order to attain the aforementioned object, the present invention is directed to an image forming apparatus comprising: a plurality of ejection heads which respectively eject droplets of a plurality of radiation curing liquids corresponding to a plurality of colors; an intermediate transfer medium on which an image is formed by the droplets ejected from the ejection heads; an evaporation device which evaporates the droplets deposited on the intermediate transfer medium; a single preliminary curing device which emits radiation onto the droplets of all of the colors deposited on the intermediate transfer medium in order to semi-cure the droplets so that the droplets of the colors do not blend with each other; and a transfer device which presses a recording medium against the intermediate transfer medium so that the image formed on the intermediate transfer medium is transferred onto the recording medium, wherein: the intermediate transfer medium is at least one of a rotary drum and an endless belt; the ejection heads are arranged in the movement direction of the intermediate transfer medium in rising order of the levels of sensitivity of the radiation curing liquids ejected from the ejection heads; the single preliminary curing device is provided on a downstream side of the ejection heads in the movement direction of the intermediate transfer medium; the droplets deposited on the intermediate transfer medium are evaporated by the evaporation device; each of the radiation curing liquids is deposited from each of the ejection heads onto the intermediate transfer medium one color at one rotation of the intermediate transfer medium, and is emitted with the radiation from the single preliminary curing device the one color at the one rotation of the intermediate transfer medium; and the intermediate transfer medium is rotated at least a number of times corresponding to a number of a number of the colors so as to form the image on the intermediate transfer medium, and then the image is transferred onto the recording medium by the transfer device.

According to the present invention, since liquid droplets in the plurality of colors can be cured substantially evenly by the single preliminary curing device, the apparatus constitution can be simplified, and then an image which does not suffer from color blending or running can be formed.

The present invention is also directed to the image forming apparatus wherein the colors include at least three colors of cyan, magenta, and yellow.

According to the present invention, a full-color image which does not suffer from color blending or running can be formed.

As described above, according to the image forming apparatus of the present invention, since the amount of solvent in the liquid droplet is reduced, the color material concentration of the image can be increased when the image is finally transferred and formed on the recording medium, and swelling of the recording medium caused by the liquid droplet solvent can be reduced. Furthermore, since the dot size can be reduced by decreasing the size of the liquid droplet, a thin image formation layer with a reduced relief effect can be obtained, thereby improving the image quality. In addition, since the plurality of liquid droplets also can be prevented from intermixing, running of the liquid droplets can be suppressed.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing of an inkjet recording apparatus as an image forming apparatus according to a first embodiment of the present invention;

FIG. 2 is a schematic perspective plan view showing an example of configuration of a print head;

FIG. 3 is a cross-sectional view of a pressure chamber unit, showing along a line 3-3 in FIG. 2;

FIG. 4 is a schematic perspective plan view showing another example of configuration of the print head;

FIG. 5 is a general schematic drawing showing an ink supply system of the inkjet recording apparatus according to the first embodiment;

FIG. 6 is a schematic block diagram showing constitution of a control system in the inkjet recording apparatus according to the first embodiment;

FIG. 7 is a diagram showing constitution of an ink component relating to each of ink colors according to the first embodiment;

FIG. 8 is a general schematic drawing of an inkjet recording apparatus as an image forming apparatus according to a second embodiment of the present invention;

FIG. 9 is a general schematic drawing of an inkjet recording apparatus as an image forming apparatus according to a third embodiment of the present invention;

FIG. 10 is a diagram showing constitution of the ink component relating to each of ink colors according to the present embodiment;

FIG. 11 is a general schematic drawing of an inkjet recording apparatus as an image forming apparatus according to a fourth embodiment of the present invention; and

FIGS. 12A and 12B are illustrative views showing in pattern form the ink components used in the first embodiment.

### DETAILED DESCRIPTION OF THE PREFERRED EMBODIMENTS

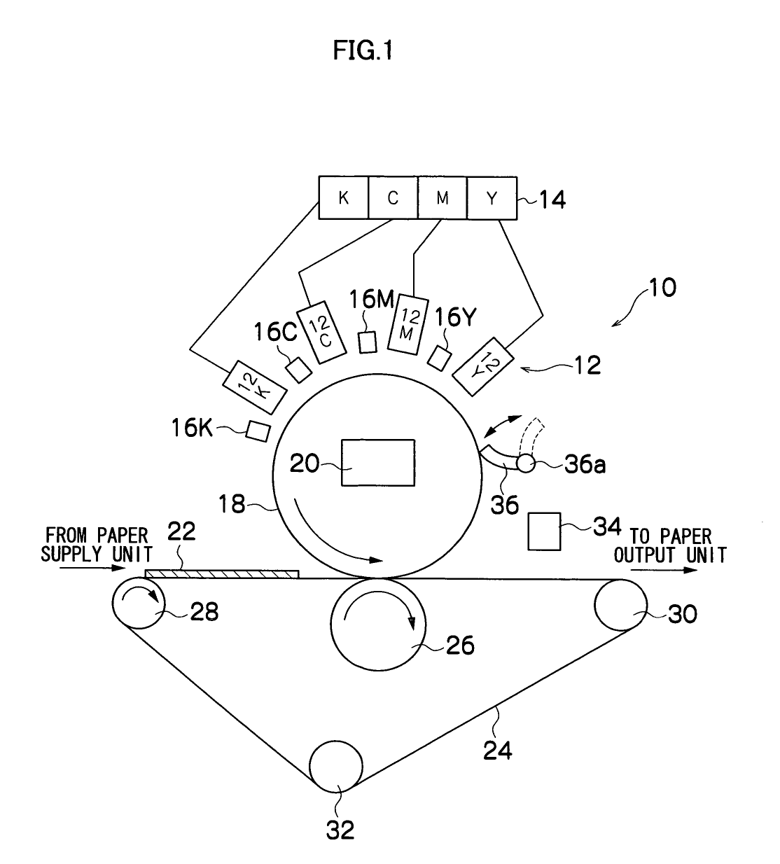

FIG. 1 is a general schematic drawing of an inkjet recording apparatus 10 as an image forming apparatus according to a first embodiment of the present invention.

As shown in FIG. 1, the inkjet recording apparatus 10 in the present embodiment comprises: a printing unit 12 comprising a print head 12Y for a Y (yellow) ink, a print head 12M for an M (magenta) ink, a print head 12C for a C (cyan) ink, and a print head 12K for a K (black) ink, provided in accordance with each of the YMCK color inks; an ink storing and loading unit 14 which stores radiation curing ink that is supplied to each of the print heads 12Y, 12M, 12C, and 12K; preliminary curing devices 16Y, 16M, 16C, and 16K disposed after the respective print heads 12Y, 12M, 12C, and 12K; a rotary drum 18 which serves as an intermediate transfer medium; a heater 20 which heats the rotary drum 18 from the interior; a conveyor belt 24 which conveys recording paper 22 supplied from a paper supply unit not shown in the drawing; a transfer roller 26 which transfers an image formed on the rotary drum 18 onto the recording paper 22 by pressing the recording paper 22 against the rotary drum 18; a drive roller 28; a driven roller 30; a tension roller 32; a main curing device 34 which is disposed after the rotary drum 18; and a cleaning blade 36 which cleans the surface of the rotary drum 18 after an image has been transferred onto the recording paper 22.

The print heads 12Y, 12M, 12C, and 12K for each of the ink colors deposit the ink of the corresponding color onto the surface of the rotary drum 18, which serves as an intermediate transfer medium, in the form of liquid droplets. As shown in FIG. 1, the print heads 12Y, 12M, 12C, and 12K are arranged in order from the upstream side of the rotation direction (indicated by an arrow in FIG. 1) of the rotary drum 18.

Each of the print heads 12Y, 12M, 12C, and 12K is a full-line head which is arranged substantially parallel to the axial direction of the rotary drum 18, and has a length which is substantially equal to the entire length of the rotary drum 18. The structure of the print heads 12Y, 12M, 12C, and 12K will be described in detail below.

The ink used in the present embodiment is radiation curing ink which hardens by receiving the emitted radiation.

Typical examples of the radiation include visible light or ultraviolet rays (UV), electromagnetic waves such as X rays, electron beams, and so on. For example, if ultraviolet rays are used as the radiation, then an ink which is cured by the ultraviolet rays may contain a component which is cured (polymerized) by ultraviolet energy (a monomer, an oligomer, or an ultraviolet curing component such as a low-molecular weight polymer or copolymer), and a polymerization initiator. In this case, when the ink is emitted with ultraviolet rays, polymerization is initiated; the ink thickens as polymerization progresses, and then eventually hardens.

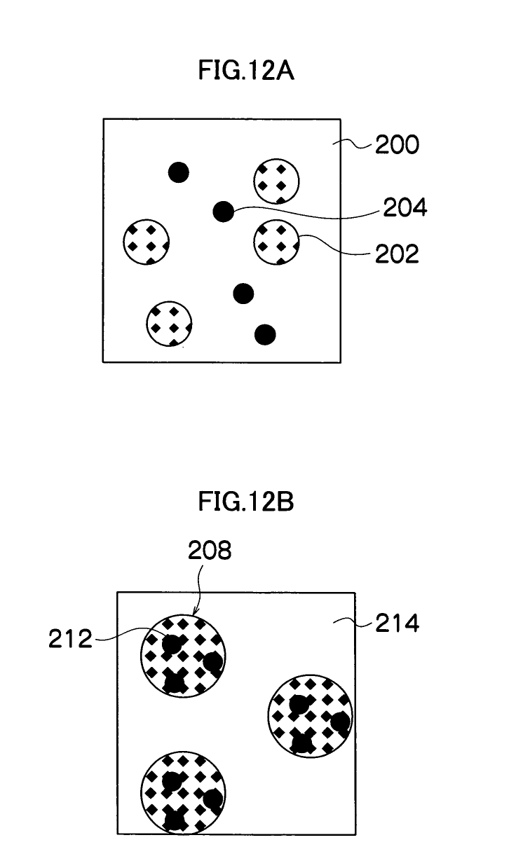

In the present invention, heat is applied to a UV curing ink deposited on an intermediate transfer medium in order to evaporate the solvent of the ink is, thereby decreasing the diameter of the deposited ink droplet. For this purpose, as shown in FIG. 12A, a water-soluble UV curing ink is used, which disperses a UV curing component 202 and a color material 204 into a solvent 200.

Alternatively, as shown in FIG. 12B, a color material 212 may be dispersed through a UV curing component 208, which disperses the UV curing component 208 into an aqueous solvent 214.

Particularly, a radiation curing ink is used in the present embodiment, which has a property that the wavelength region of the radiation causing the curing reaction to progress is different for each color.

In the present embodiment, the wavelength regions of the radiation that effectively hardens the ink of each color (in other words, the radiation for YMCK curing inks which are ejected respectively from the print head 12Y, 12M, 12C, and 12K) are all different from each other.

More specifically, the radiation curing Y ink has a property which effectively hardens under radiation in a certain wavelength region L1. Likewise, the M ink has a property which effectively hardens under radiation in a wavelength region L2, the C ink has a property which effectively hardens under radiation in a wavelength region L3, and the K ink has a property which effectively hardens under radiation in a wavelength region L4.

In this case, the wavelength regions L1 to L4 may have overlapping parts. However, when the peak of each wavelength region (the wavelength of proportion at which the ink corresponding to the color hardens most effectively) is different, or when the wavelength region and ink do not match, then it is considered that curing of the ink is unlikely to be affected.

Moreover, if the wavelength region of the radiation with which each of the inks is emitted and cured is sufficiently narrowed, then overlapping parts between the wavelength regions that most affect the curing of each ink can be reduced as far as possible or completely eliminated. Therefore, it is possible to prevent unintentional further curing when the ink is emitted in duplicate by the radiation.

The preliminary curing devices 16Y, 16M, 16C, and 16K are provided respectively for the print head 12Y, 12M, 12C, and 12K, respectively following the print head 12Y, 12M, 12C, 12K. The preliminary curing devices 16Y, 16M, 16C, and 16K respectively emit the YMCK inks with radiation in a wavelength region for curing the ink corresponding to each of the colors so as to semi-cure the ink, principally.

For example, the radiation emitted by the preliminary curing device 16Y is within a wavelength region for principally curing the Y ink, or an even narrower wavelength region within this wavelength region. In this case, as described above, if the wavelength regions of radiations are sufficiently narrowed so that there is no overlap between the wavelength regions for principally curing the YMCK inks, then it is possible to suppress excessive curing of the ink when emitted in duplicate.

Here, the term “semi-curing” is a curing degree that an ink droplet on the rotary drum 18 does not intermix (or color-blend) with another ink droplet, but is not a curing degree that the ink cannot be transferred onto the recording paper 22 at a later stage.

When an ultraviolet curing ink is used as the radiation curing ink, ultraviolet ray emitting devices which emit ultraviolet rays in wavelength regions for curing (semi-curing) the YMCK ultraviolet curing inks are used as the preliminary curing devices 16Y, 16M, 16C, and 16K for semi-curing the ultraviolet curing inks. As a light source used for the preliminary curing devices 16Y, 16M, 16C, and 16K, for example, an ultraviolet LED element or ultraviolet LD element which emits ultraviolet rays in each wavelength region may be used favorably.

The ink storing and loading unit 14 comprises ink tanks storing colored inks (radiation (ultraviolet) curing ink) corresponding to the print heads 12Y, 12M, 12C, and 12K. Each of the tanks communicates with each of the print heads 12Y, 12M, 12C, and 12K via an ink supply pipe.

The ink storing and loading unit 14 has a warning device (for example, a display device or an alarm sound generator) for warning when the remaining amount of any ink is low, and has a mechanism for preventing loading errors among the colors.

There are no particular limitations on the rotary drum 18 as an intermediate transfer medium, but for example, a rotatable, metallic, hollow roller that silicone rubber or fluorine resin is wrapped around its outer periphery is disposed so that a fixed gap is maintained between the outer peripheral surface of the rotary drum 18 and the ink ejection ports (nozzles) of the print heads 12Y, 12M, 12C, and 12K. The rotary drum 18 is controlled by a driving device (not shown in the drawing) to rotate at a predetermined speed in the direction of an arrow in FIG. 1.

The heater 20 is provided substantially parallel to the axial direction of the rotary drum 18 in the interior of the rotary drum 18, having a length which is substantially identical to the entire length of the rotary drum 18, which serves to heat the entire rotary drum 18 to a predetermined temperature. In this case, the heater 20 is an evaporation device which evaporates the ink solvent by heating the ink droplets deposited onto the surface of the rotary drum 18 from the respective print heads 12Y, 12M, 12C, and 12K.

Incidentally, the evaporation device is not limited to the heater 20, and may be a device which evaporates the solvent by blasting hot air onto the ink droplets deposited on the surface of the rotary drum 18, or a device which evaporates the solvent using thermal energy generated through light irradiation. If the light irradiation method is adopted, the preliminary curing devices 16Y, 16M, 16C, and 16K may double as the evaporation device. If an evaporation device other than the heater 20 is used, the heater 20 may be omitted.

The conveyor belt 24 transfers an image from the rotary drum 18 to the recording paper 22 by conveying the recording paper 22, supplied from the paper supply unit (not shown) between the rotary drum 18 and transfer roller 26, and then conveys the recording paper 22 to a paper output unit (not shown). The conveyor belt 24 is a heat-resistant endless belt having a greater width dimension than the width of the recording paper 22, and is wrapped around the drive roller 28, the driven roller 30, and the tension roller 32.

As similar to the rotary drum 18, the transfer roller 26 is also a rotatable metallic roller that the outer periphery is covered in rubber, for example. The transfer roller 26 is disposed on the opposite side to the conveyor belt 24 with respect to the rotary drum 18, in parallel to the axial direction of the rotary drum 18, having a substantially identical length to the entire length of the rotary drum 18.

When the recording paper 22 conveyed on the conveyor belt 24 passes between the rotary drum 18 and transfer roller 26, the transfer roller 26 presses the recording paper 22 against the rotary drum 18, so that the image on the rotary drum 18, formed by ejecting ink droplets from the print heads 12Y, 12M, 12C, and 12K while rotating the rotary drum 18, evaporating the ink droplets using the heater 20, and semi-curing the ink droplets using the preliminary curing devices 16Y, 16M, 16C, 16K, is transferred from the rotary drum 18 onto the recording paper 22.

At this time, the contact pressure with which the transfer roller 26 presses the recording paper 22 against the surface of the rotary drum 18 is controlled to a predetermined pressure. The control systems for these operations will be described below.

The main curing device 34 is disposed above the conveyor belt 24 following the rotary drum 18. The main curing device 34 is emitted with radiation (ultraviolet rays) when the recording paper 22 is conveyed, thereby full-curing the image on the recording paper 22 so as to fix the image.

For example, if an ultraviolet curing ink is used as the radiation curing ink, a mercury lamp, metal halide lamp, and other lamps is preferably adopted to the main curing device 34, having a wider wavelength region and a larger light output than the ultraviolet LED element which is used in the preliminary curing devices 16Y, 16M, 16C, and 16K (in other words, having a wavelength region that can cure all of the YMCK inks).

In order to clean the surface of the rotary drum 18 after the image formed on the surface has been transferred onto the recording paper 22, the cleaning blade 36 is provided in front of the print heads 12Y, 12M, 12C, and 12K, which cleans the surface of the rotary drum 18 before commencing printing of the next image. The cleaning blade 36 is formed so that a thick plate-form member made of a non-woven material or an elastic material such as rubber is disposed rotatably about a spindle 36a. When cleaning the surface of the rotary drum 18, the tip end portion of the cleaning blade 36 slides over the surface of the rotary drum 18.

Next, the print heads 12Y, 12M, 12C, and 12K will be described. The print heads 12Y, 12M, 12C, and 12K provided for the respective ink colors have a common structure, and hence in the following description, the reference numeral 50 will be used to represent the print heads.

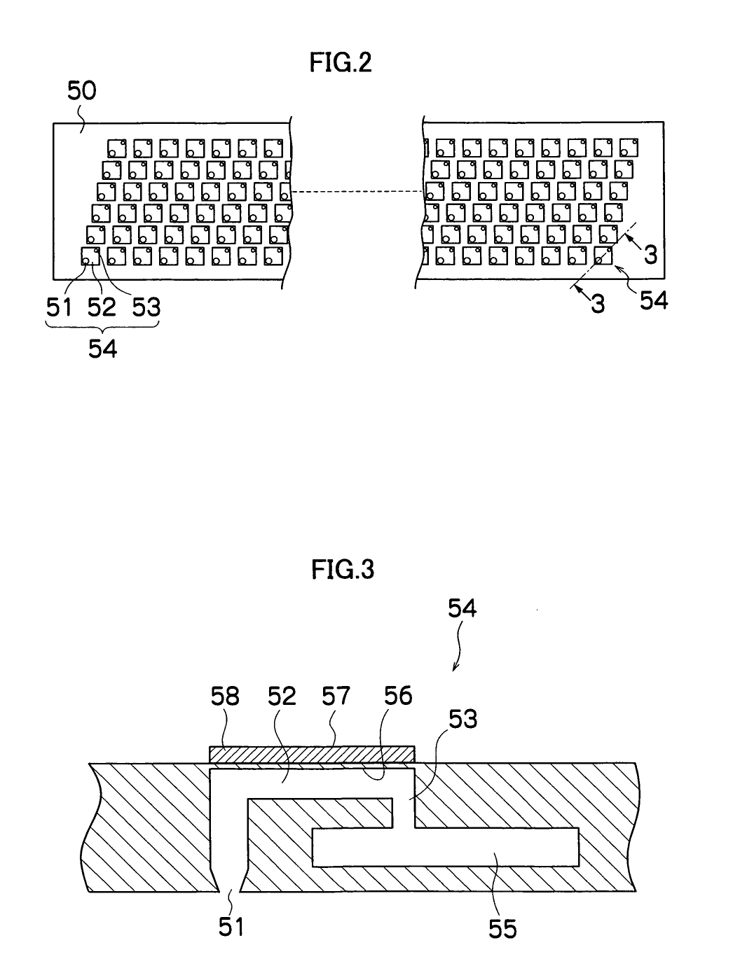

FIG. 2 is a perspective plan view showing an example of configuration of the print head 50 (12Y, 12M, 12C, and 12K).

As shown in FIG. 2, the print head 50 in the present embodiment is constituted by a plurality of pressure chamber units 54, respectively comprising a nozzle 51 which ejects the ink, a pressure chamber 52 which applies pressure to the ink during ink ejection, and an ink supply port 53 which supplies the ink to the pressure chamber 52 through a common flow channel (not shown in FIG. 2). The pressure chamber units 54 are arranged two-dimensionally, so that the nozzles 51 are arranged at a high density.

As shown in FIG. 2, each of the pressure chambers 52 has a substantially square form when seen from above. The nozzle 51 is formed at one end of the diagonal, and the ink supply port 53 is provided at the other end.

FIG. 3 is a cross-sectional view of one of the pressure chamber units 54, showing cross-section along the dot-dash line 3-3 in FIG. 2.

As shown in FIG. 3, the pressure chamber unit 54 is formed by the pressure chamber 52 in which the nozzle 51 for ejecting the ink is formed. The common flow channel 55 which supplies the ink to the pressure chamber 52 communicates with the pressure chamber 52 via the supply port 53. One surface of the pressure chamber 52 (the ceiling face in FIG. 3) is constituted by a typical ejection diaphragm 56, and a piezoelectric element 58 comprising an individual electrode 57 is joined to the top of the diaphragm 56.

When the piezoelectric element 58 is deformed by applying a drive voltage to the individual electrode 57, then the diaphragm 56 bends, and the volume of the pressure chamber 52 is reduced in response to this distortion of the diaphragm 56, thereby ejecting the ink through the nozzle 51. After the ink is ejected, the piezoelectric element 58 returns to normal, the pressure chamber 52 returns to its original volume, and new ink is supplied to the pressure chamber 52 from the common flow channel 55 via the supply port 53.

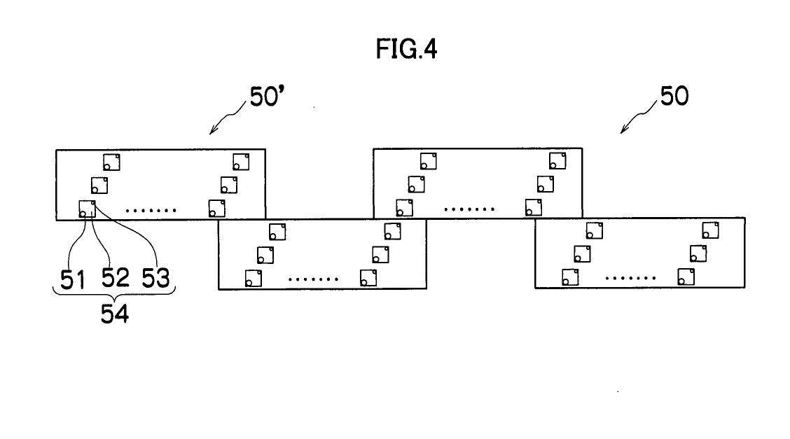

FIG. 4 is a perspective plan view showing another example of the configuration of the print head 50.

As shown in FIG. 4, a full-line print head 50 can be composed of a plurality of short arrayed head units 50′ arranged in the form of a staggered matrix and combined so as to arrange the plurality of nozzles 51 (pressure chamber units 54) two-dimensionally having lengths that correspond to the entire width of the rotary drum 18 (recording paper 22).

Next, the ink supply system relating to the print head 50 will be described.

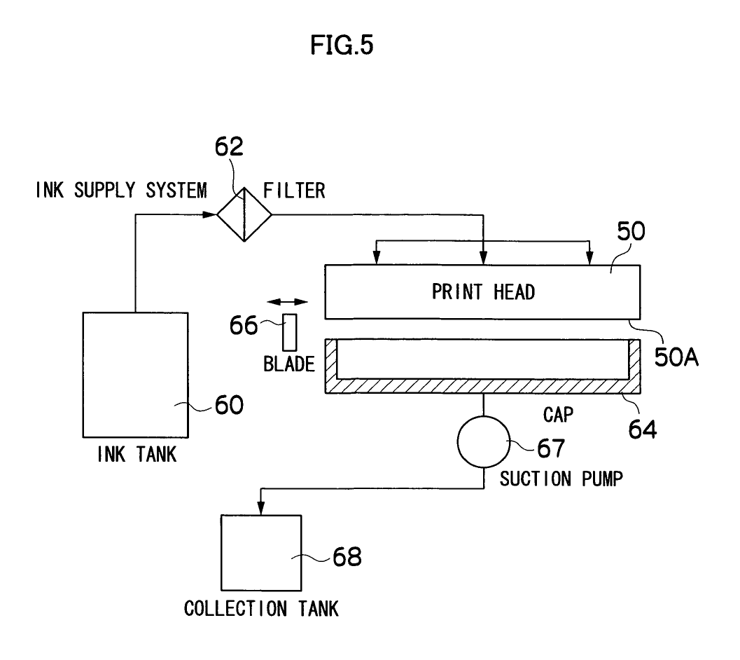

FIG. 5 is a schematic drawing showing the configuration of the ink supply system in the inkjet recording apparatus 10. The ink tank 60 is a base tank that supplies ink to the print head 50 and is set in the ink storing and loading unit 14 described with reference to FIG. 1. The aspects of the ink tank 60 include a refillable type and a cartridge type: when the remaining amount of ink is low, the ink tank 60 of the refillable type is filled with ink through a filling port (not shown) and the ink tank 60 of the cartridge type is replaced with a new one. In order to change the ink type in accordance with the intended application, the cartridge type is suitable, and it is preferable to represent the ink type information with a bar code or the like on the cartridge, and to perform ejection control in accordance with the ink type. The ink tank 60 in FIG. 5 is equivalent to the ink storing and loading unit 14 in FIG. 1 described above.

As shown in FIG. 5, a filter 62 for removing foreign matter and bubbles is disposed in a pipe connecting the ink tank 60 and the print head 50. The filter mesh size is preferably equal to or less than the diameter of the nozzle of the print head 50 (typically, approximately 20 μm).

Although not shown in FIG. 5, it is preferable to provide a sub-tank integrally to the print head 50 or nearby the print head 50. The sub-tank has a damper function for preventing variation in the internal pressure of the print head 50 and a function for improving refilling of the print head 50.

The inkjet recording apparatus 10 is also provided with a cap 64 as a device to prevent the nozzles from drying out or to prevent an increase in the ink viscosity in the vicinity of the nozzles, and a cleaning blade 66 as a device to clean the nozzle face 50A.

A maintenance unit including the cap 64 and the cleaning blade 66 can be relatively moved with respect to the print head 50 by a movement mechanism (not shown), and is moved from a predetermined holding position to a maintenance position below the print head 50 as required.

The cap 64 is displaced up and down relative to the print head 50 by an elevator mechanism (not shown). When the power is turned OFF or during print standby, the cap 64 is raised to a predetermined elevated position so as to come into close contact with the print head 50, and thus the nozzle area of the nozzle face 50A is covered by the cap 64.

As similar to the cleaning blade 36 for cleaning the rotary drum 18 described above, the cleaning blade 66 of the print head 50 is also constituted by an elastic member made of rubber or the like, and is capable of sliding over the ink ejection face (nozzle face 50A) of the print head 50 by means of a blade moving mechanism not shown in the drawing. When an ink droplet or foreign object adheres to the nozzle face 50A, the nozzle face 50A can be wiped clean by sliding the cleaning blade 66 over the nozzle face 50A.

During printing or standby, when the frequency of use of specific nozzles 51 is reduced and ink viscosity increases in the vicinity of the nozzles, a preliminary discharge is made to eject the degraded ink toward the cap 64.

Also, when bubbles have become intermixed in the ink inside the print head 50 (inside the pressure chamber 52), the cap 64 is placed on the print head 50, the ink inside the pressure chamber 52 (the ink in which bubbles have become intermixed) is removed by suction with a suction pump 67, and the suction-removed ink is sent to a collection tank 68. This suction action entails the suctioning of degraded ink of which viscosity has increased (hardened) also when initially loaded into the head, or when service has started after a long period of being stopped.

When a state in which ink is not ejected from the print head 50 continues for a certain amount of time or longer, the ink solvent in the vicinity of the nozzles 51 evaporates and ink viscosity increases. In such a state, ink can no longer be ejected from the nozzle 51 even if the piezoelectric element 58 for the ejection driving is operated. Before reaching such a state (in a viscosity range that allows ejection by the operation of the piezoelectric element 58) the piezoelectric element 58 is operated to perform the preliminary discharge to eject the ink of which viscosity has increased in the vicinity of the nozzle toward the ink receptor. After the nozzle face 50A is cleaned by a wiper such as the cleaning blade 66 provided as the cleaning device for the nozzle face 50A, a preliminary discharge is also carried out in order to prevent the foreign matter from becoming mixed inside the nozzles 51 by the wiper sliding operation. The preliminary discharge is also referred to as “dummy discharge”, “purge”, “liquid discharge”, and so on.

When bubbles have become intermixed in the nozzle 51 or the pressure chamber 52, or when the ink viscosity inside the nozzle 51 has increased over a certain level, ink can no longer be ejected by the preliminary discharge, and a suctioning action is carried out as follows.

More specifically, when bubbles become mixed into the ink in the nozzle 51 and pressure chamber 52 or the viscosity of the ink in the nozzle 51 rises to or above a certain level, the ink cannot be ejected from the nozzle 51 even when the piezoelectric element 58 is operated. In this case, the cap 64 is placed on the nozzle face 50A of the print head 50, and a suction operation is performed to remove the ink intermixed with bubbles or viscous ink from the pressure chamber 52 using the suction pump 67.

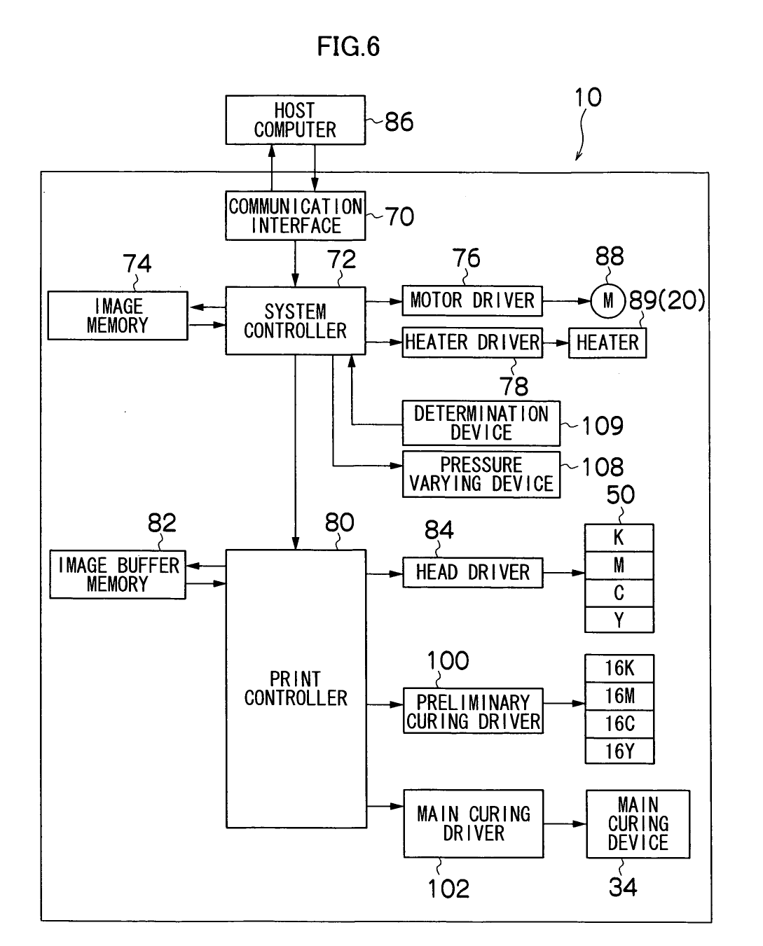

However, this suction action is performed with respect to all the ink in the pressure chamber 52, so that the amount of ink consumption is considerable. Therefore, a preferred aspect is one in which a preliminary discharge is performed when the increase in the viscosity of the ink is small. The cap 64 described with reference to FIG. 6 serves as the suctioning device and also as the ink receptacle for the preliminary discharge.

It is also preferable to divide the inside of the cap 64 into a plurality of areas corresponding to the nozzle arrays using partition walls so that suction can be performed on each of the partitioned areas selectively using a selector or the like.

Next, the control system of the inkjet recording apparatus 10 according to the present embodiment will be described.

FIG. 6 is a principal block diagram showing constitution of a control system in the inkjet recording apparatus 10.

As shown in FIG. 6, the inkjet recording apparatus 10 comprises a communication interface 705 a system controller 72, memory 74, a motor driver 76, a heater driver 78, a print controller 80, an image buffer memory 82, a head driver 84, and the like.

The communication interface 70 is an interface unit for receiving image data sent from a host computer 86. A serial interface such as USB, IEEE1394, Ethernet, wireless network, or a parallel interface such as a Centronics interface may be used as the communication interface 70. A buffer memory (not shown) may be mounted in this portion in order to increase the communication speed. The image data sent from the host computer 86 is received by the inkjet recording apparatus 10 through the communication interface 70, and is temporarily stored in the memory 74. The memory 74 is a storage device for temporarily storing images inputted through the communication interface 70, and data is written and read to and from the memory 74 through the system controller 72. The memory 74 is not limited to a memory composed of semiconductor elements, and a hard disk drive or another magnetic medium may be used.

The system controller 72 is a control unit for controlling various units such as the communication interface 70, memory 74, motor driver 76, and heater driver 78. The system controller 72 is constituted by a central processing unit (CPU), peripheral circuits thereof, and so on, and controls communication with the host computer 86 and writing and reading to and from the memory 74. The system controller 72 also generates control signals for controlling the motor 88 and heater 89 of the conveyance system.

The motor driver (drive circuit) 76 drives the motor 88 in accordance with commands from the system controller 72. The motor 88 includes a motor for driving the rotary drum 18, the transfer roller 26, the drive roller 28 which moves the conveyor belt 24, and the like. In addition, the motor driver 76 includes a driver for controlling the motor which drives the rotary drum 18, transfer roller 26, drive roller 28, and the like.

The heater driver 78 drives the heater 20 disposed in the rotary drum 18 or a heater 89 serving as a device for regulating the temperature of the print head 50, according to the commands from the system controller 72.

The print controller 80 has a signal processing function for performing various tasks, compensations, and other types of processing for generating print control signals from the image data stored in the memory 74 in accordance with commands from the system controller 72 so as to supply the generated control signal (print data) to the head driver 84. Prescribed signal processing is carried out in the print controller 80, and the ejection amount and the ejection timing of the ink droplets from the respective print heads 50 are controlled via the head driver 84, according to the print data. By this means, prescribed dot size and dot positions can be achieved.

The print controller 80 also controls the preliminary curing devices 16Y, 16M, 16C, and 16K and the main curing device 34 shown in FIG. 1. When a control signal is transmitted from the print controller 80 to a preliminary curing driver 100 and a main curing driver 102, the preliminary curing driver 100 and main curing driver 102 are driven in accordance with the signal to operate the preliminary curing devices 16Y, 16M, 16C, 16K, and main curing device 34.

The print controller 80 is provided with the image buffer memory 82; and image data, parameters, and other data are temporarily stored in the image buffer memory 82 when image data is processed in the print controller 80. The aspect shown in FIG. 6 is one in which the image buffer memory 82 accompanies the print controller 80; however, the memory 74 may also serve as the image buffer memory 82. Also possible is an aspect in which the print controller 80 and the system controller 72 are integrated to form a single processor.

The head driver 84 drives the actuators of the print heads 50 of the respective colors according to the print data supplied by the print controller 80. The head driver 84 can be provided with a feedback control system for maintaining constant drive conditions for the print heads 50.

Various control programs are stored in a program storage unit (not shown). A control program is read and executed in accordance with a command from the system controller 72. The program storage unit may employ semiconductor memory such as ROM or EEPROM, or may be constituted by a magnetic disk or the like. Alternatively, an external interface may be provided and a memory card or PC card used as the program storage unit. Needless to say, a plurality of these recording media may be provided. Incidentally, the program storage unit may double as a recording device (not shown) for recording operating parameters, and the like.

A pressure varying device 108 varies the pressure applied between the rotary drum 18 and the transfer roller 26 so that the pressure between the rotary drum 18 and the transfer roller 26 is optimized according to following information: information (such as the thickness, the type, and the like) of the recording paper 22 sandwiched between the rotary drum 18 and the transfer roller 26; information relating to the properties of the used ink; information relating to the amount of ink solvent which has been evaporated or the degree of semi-curing; and information relating to the conveyance speed of the recording paper 22. Therefore, since the image (ink film thickness) transferred onto the recording paper 22 is reduced in thickness, then the relief effect of the image can be lessened.

In the inkjet recording apparatus 10, the type and thickness of the recording paper 22 supplied from the paper supply unit and the ink ejection amount are determined by a determination device 109. Control is performed in accordance with the determination result to vary the pressure applied between the rotary drum 18 and transfer roller 26 shown in FIG. 1 using the pressure varying device 108.

Hereinafter, an action of the present embodiment will be described.

According to the present embodiment, the inkjet recording apparatus 10 is constituted as described above. More specifically, the paper size of the recording paper 22 is 500 mm (conveyance direction)×350 mm (width direction). In other words, this size is so-called Japanese A3 plus size. In addition, the diameter of the rotary drum 18 is set at φ200 mm, and then the rotation speed of the rotary drum 18 is set at one revolution per second (1 rev/sec). In terms of the circumferential speed of the rotary drum 18, this is equivalent to approximately 600 mm/sec. At this speed, approximately 100 sheets of A4 paper can be printed per minute. The temperature of the rotary drum 18 is maintained at 70° C. by the heater 20.

On conditions described above, the radiation (ultraviolet) curing Y ink is firstly deposited from the print head 12Y onto the surface of the rotating rotary drum 18 covered in silicone rubber or the like, as shown in FIG. 1. As described above, the Y ink is largely cured by radiation (ultraviolet rays) emitted in a certain wavelength region by the preliminary curing device 16Y disposed in immediate vicinity following the print head 12Y (on the downstream side in the rotation direction of the rotary drum 18).

After the Y ink is ejected from the print head 12Y, the preliminary curing device 16Y immediately emits radiation (ultraviolet rays) in a wavelength for curing the Y ink, and thus the ejected Y ink is cured (semi-cured) so as not to blend with inks of other colors.

Next, as the rotary drum 18 continues to rotate, the radiation (ultraviolet) curing M ink is deposited onto the surface of the rotary drum 18 from the print head 12M. After the M ink is ejected, radiation (ultraviolet rays) in a wavelength for mainly curing the M ink is emitted onto the M ink which has been ejected immediately beforehand on the surface of the rotary drum 18, by the preliminary curing device 16M disposed following the print head 12M, thereby semi-curing the M ink.

At this time, the Y ink ejected previously is also emitted with the radiation emitted from the M ink preliminary curing device 16M, but since the wavelength region of the radiation for curing the Y ink is different to the wavelength region of the radiation for curing the M ink, the latter radiation has little effect on the curing of the Y ink.

Next, as the rotary drum 18 continues to rotate, the radiation (ultraviolet) curing C ink is deposited onto the surface of the rotary drum 18 from the print head 1 2C, and then radiation having a wavelength for mainly curing the C ink is emitted from the C ink preliminary curing device 1 6C. Finally, the radiation (ultraviolet) curing K ink is deposited onto the surface of the rotary drum 18 from the print head 12K, and then radiation having a wavelength for mainly curing the K ink is emitted from the preliminary curing device 16K.

In this case, the ink ejected first is emitted with radiation every time another ink is ejected subsequently. However, since the wavelength region for curing the ink ejected first is different to the wavelength regions of the radiation for curing the other inks, the ink ejected first is not cured to such an extent that it cannot be transferred onto the recording paper 22 at a later stage.

Furthermore, while each of the inks of the colors is ejected as the rotary drum 18 rotates and radiation is emitted to cure the ink of the corresponding color every time ink is ejected, the rotary drum 18 is heated (to 70° C., for example) by the heater 20. Therefore, the ink solvent is gradually evaporated by means of this heating.

At this time, since the duration of the heating increases steadily toward the ink ejected first, then a gradually larger amount of ink solvent is evaporated. In this case, if a ratio of color material and solvent in the ink ejected first is the same as the ratio in the inks ejected subsequently, the amount of evaporated solvent in the ink ejected first may be different from that in the inks ejected subsequently. Accordingly, since the color material concentration of the respective inks differs at the time of transfer onto the recording paper 22, it may cause deterioration in image quality.

If the remaining amount of solvent on the intermediate transfer medium differs for each color when transferring onto the recording medium, the transfer unevenness may occur. In addition, it may become difficult to set optimum pressure setting conditions for the pressure varying device 108.

Therefore, in the present embodiment, the amount of solvent in the ink is adjusted to increase steadily toward the ink ejected first.

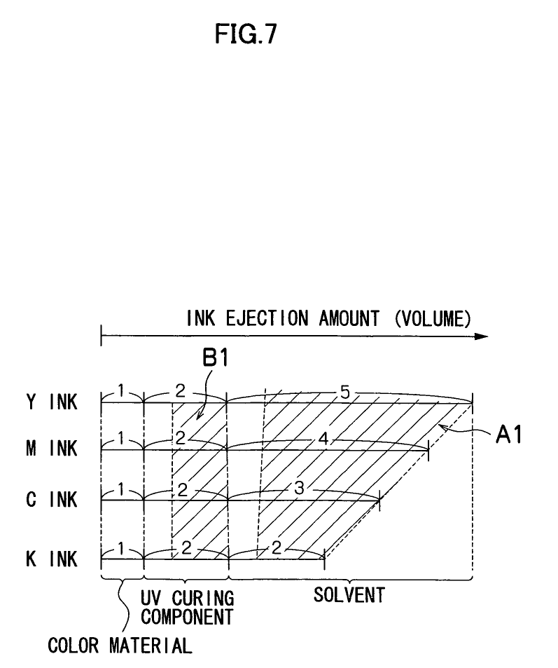

FIG. 7 shows the proportions of color material, UV (radiation) curing component and solvent in the ejection amount (ejection volume) of each of the inks. Here, it is assumed that each of the inks is an aqueous UV curing ink.

In the present embodiment, since the inks are ejected in order of Y ink, M ink, C ink, and K ink, then the amount of solvent in the Y ink ejected first is made great, and the amount of solvent in the other inks is reduced steadily in order of ejection.

More specifically, a ratio between the color material and UV curing component in the ink ejection volume is the same in each of the inks, in other word, the ratio is 1:2. However, a ratio between the color material and solvent is 1:5 in the Y ink, 1:4 in the M ink, 1:3 in the C ink, and 1:2 in the K ink. Therefore, the Y ink ejected first has the greatest amount of solvent, and then the amount of solvent decreases steadily thereafter in order of ejection.

Since the ratio between the color material and UV curing component is substantially identical, the amount of ejected ink rises steadily toward the ink ejected earlier in accordance with the amount of solvent. For example, as shown in FIG. 7, the ratio of color material:UV curing component:solvent in the K ink ejected last is 1:2:2. On the other hand, the ratio of color material:UV curing component:solvent in the Y ink ejected first is 1:2:5. Accordingly, the amount of ejected ink is 1+2+2=5 in the case of the K ink, but 1+2+5=8 in the case of the Y ink, and therefore the Y ink ejection amount is greater than the K ink ejection amount by 60%.

As described above, since the amount of solvent (in other words, the ink ejection amount) is adjusted in accordance with the ejection sequence, the effect of evaporation through heating can be made the same. Therefore, the post-evaporation dot diameter (the image concentration) can be made the same. In FIG. 7, a region A1 indicated by diagonal lines denotes the amount of evaporated solvent on the rotary drum 18, and a region B1 indicated by diagonal lines denotes the amount of cured UV component on the rotary drum 18.

In this way, while the recording paper 22 is conveyed in synchronization with the rotation of the rotary drum 18, an image formed on the rotary drum 18 (an image to be transferred onto the recording paper 22) is subjected to evaporation and semi-curing. Then, the recording paper 22 is pressed against the rotary drum 18 by the transfer roller 26, whereby the image is transferred from the rotary drum 18 to the recording paper 22.

The recording paper 22 onto which the image has been transferred is conveyed under the main curing device 34 by the conveyor belt 24, and is emitted with main curing radiation by the main curing device 34. Consequently, the image is fixed onto the recording paper 22, whereupon the recording paper 22 is output to the paper output unit (not shown).

As described above, the ink ejection in the present embodiment is performed in order of Y ink, M ink, C ink, and K ink. As this reason, when the image is transferred onto the recording paper 22, the colors are transferred in order of K-C-M-Y from the bottom, and hence the lightest color forms the top layer.

After the image is transferred onto the recording paper 22, the surface of the rotary drum 18 is cleaned by the cleaning blade 36. Then, printing of the next image begins, and similar processes to those described above are repeated.

According to the present embodiment, the ink droplets deposited onto the rotary drum 18 are heated to evaporate the solvent, and the radiation for curing the radiation curing component of the ink is emitted in a different wavelength region for each ink. Therefore, the inks of each color can be semi-cured so that color blending does not occur when each of the inks is ejected, and the volume of each of the inks can be reduced so that the image is formed thinly on the recording paper 22. Consequently, the so-called relief effect can be decreased, and the image quality can be improved.

Furthermore, since the solvent is evaporated, the recording paper 22 is not swollen by the ink solvent. Moreover, since unevenness in the image concentration can be eliminated by further evaporating the solvent, an improvement in the image concentration quality can be achieved. In particular, since the proportion of solvent and the ink ejection amount are adjusted so that the amount of ink solvent is reduced steadily in order of ejection, the ink concentration can be made even among the ink colors after the ink solvent is evaporated.

Additionally, since transfer from the rotary drum 18 to the recording paper 22 is performed by pressing the recording paper 22 against the rotary drum 18, penetration of the ink into the recording paper 22 is precipitated by the pressure applied during transfer, and hence fixing can be accelerated.

Next, a second embodiment of the present invention will be described hereinafter.

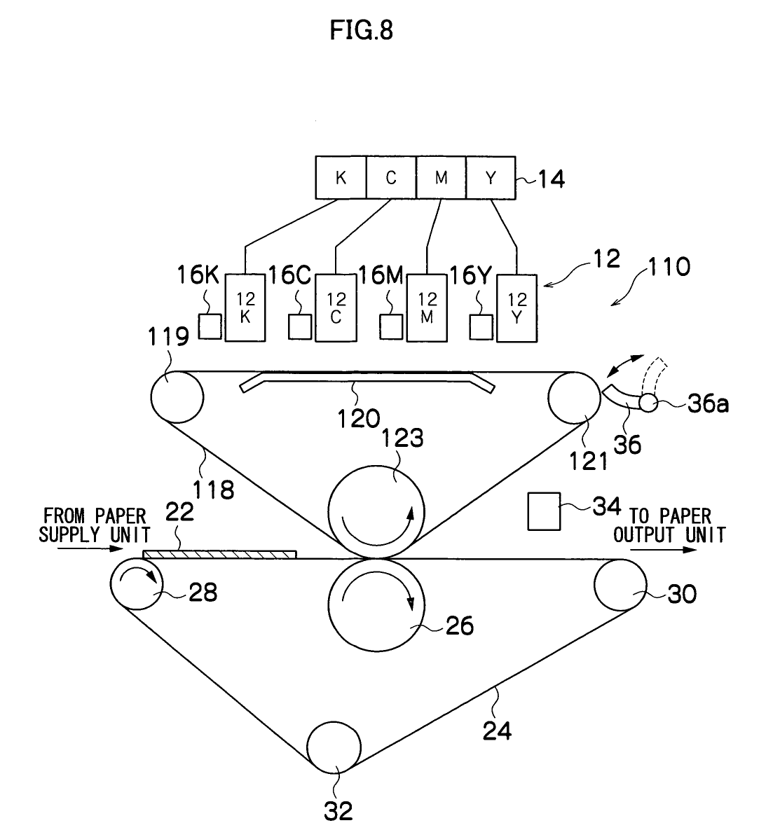

FIG. 8 shows the schematic constitution of an inkjet recording apparatus 110 according to the second embodiment.

In the second embodiment, an endless transfer belt is used instead of the rotary drum which serves as the intermediate transfer medium in the first embodiment described above.

As shown in FIG. 8, the inkjet recording apparatus 110 of the second embodiment comprises: the printing unit 12 including the print head 12Y for the Y ink, the print head 12M for the M ink, the print head 12C for the C ink, and the print head 12K for the K ink, provided in accordance with each of the YMCK color inks; the ink storing and loading unit 14 which respectively stores radiation curing ink supplied to the print heads 12Y, 12M, 12C, and 12K; the preliminary curing devices 16Y, 16M, 16C, and 16K which are disposed following the respective print heads 12Y, 12M, 12C, and 12K, respectively; a transfer belt 118 serving as an intermediate transfer medium; a heating plate 120 which heats the transfer belt 118 from the inside; the conveyor belt 24 which conveys the recording paper 22 supplied from the paper supply unit (not shown); a first transfer roller 123 and a second transfer roller 26 which transfer an image formed on the transfer belt 118 to the recording paper 22 by pressing the recording paper 22 and transfer belt 118 together from either side; the drive roller 28 which moves the conveyor belt 24; the driven roller 30; the tension roller 32; the main curing device 34 disposed following the transfer belt 118; and the cleaning blade 36 which cleans the transfer belt 118 after an image has been transferred onto the recording paper 22.

The present embodiment differs from the first embodiment merely in that the endless transfer belt 118 in FIG. 8 is used as an intermediate transfer medium instead of the rotary drum 18 in FIG. 1. Therefore, the present embodiment is identical to the first embodiment in all other components.

More specifically, the YMCK radiation curing inks which are cured when emitted with radiation in different wavelength regions are used for each color, and the inks of colors is deposited onto the transfer belt 118 in order of Y, M, C, and K. After ink ejection, the ink is immediately emitted with radiation in a wavelength region for semi-curing the ink of the corresponding color.

The transfer belt 118 is wrapped around rollers 119 and 121, and the first transfer roller 123. The heating plate 120 is disposed between the rollers 119 and 121 in order to heat the transfer belt 118 from below while keeping the transfer belt 118 flat.

There are no particular limitations on the specific constitution of those components, but as an example, the printing space between the rollers 119 and 121 is set to 300mm, and the temperature to which the transfer belt 118 is heated by the heating plate 120 is set to 70° C.

The transfer belt 118 is kept flat by the heating plate 120, and the print heads 12Y, 12M, 12C, and 12K for each color are disposed in series thereabove from the upstream side of the movement direction of the transfer belt 118. The preliminary curing device 1 6Y,16M, 16C, and 16K for respectively semi-curing the inks of the colors are disposed respectively in immediate vicinity following the print head 1 2Y, 12M, 12C, and 12K.

When the transfer belt 118 passes beneath the respective print heads 12Y, 12M, 12C, and 12K, then each of the color inks is deposited onto the transfer belt 118. Each of the inks is semi-cured by its corresponding preliminary curing device 16Y, 16M, 16C, or 16K so that color-blending does not occur among the ink droplets. Simultaneously, since the inks are heated by the heating plate 120 so that the ink solvent evaporates, then a transfer image is formed on the transfer belt 118.

The recording paper 22 is conveyed by the conveyor belt 24 in synchronization with the movement of the transfer belt 118. When the recording paper 22 passes between the first transfer roller 123 and second transfer roller 26, the transfer belt 118 and recording paper 22 are pressed together. Therefore, the image is transferred from the transfer belt 118 onto the recording paper 22.

When the recording paper 22 is conveyed under the main curing device 34 by the conveyor belt 24 onto which the image has been transferred, the recording paper 22 is emitted with main curing radiation by the main curing device 34 so that the image is fixed onto the recording paper 22. Then, the recording paper 22 is output to a paper output unit (not shown in FIG. 8). On the other hand, after the image has been transferred, the surface of the transfer belt 118 is cleaned by the cleaning blade 36, and then printing of the next image begins.

Consequently, in the present embodiment, it is possible to obtain similar effects to those of the first embodiment.

Next, a third embodiment of the present invention will be described hereinafter.

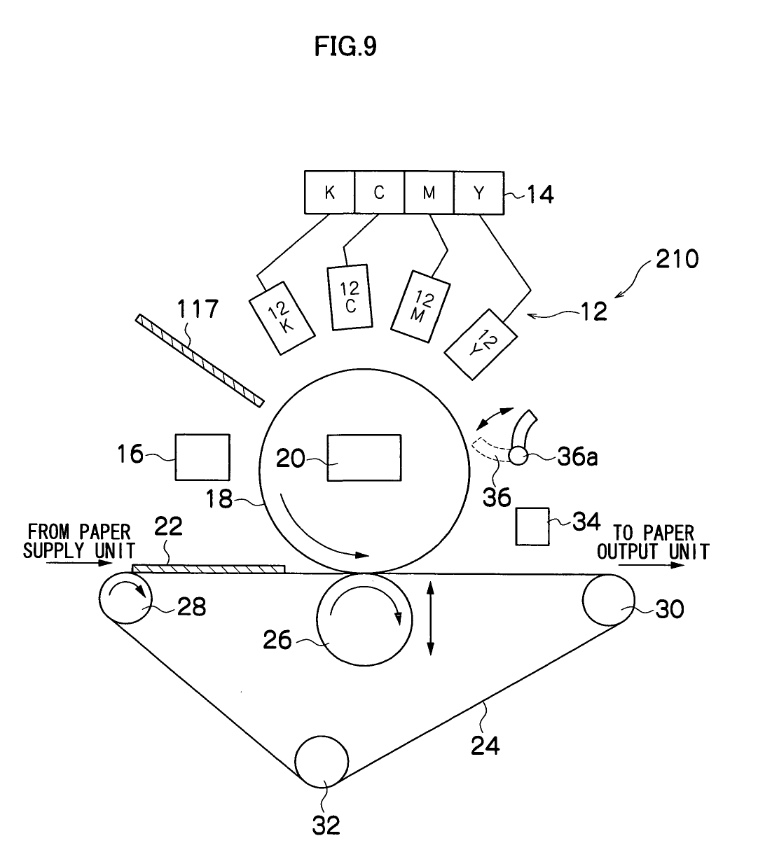

FIG. 9 shows the schematic constitution of an inkjet recording apparatus 210 according to the third embodiment.

In the present embodiment, a rotary drum 18 in FIG. 9 is used as an intermediate -transfer medium as similar to the first embodiment, but only one preliminary curing device 16 is provided. Additionally, in the first embodiment, an image is formed by one rotation of the rotary drum 18, but in the present embodiment, only one color is ejected and semi-cured by radiation emitted from the preliminary curing device 16 for every rotation of the rotary drum 18, and hence the rotary drum 18 rotates once for each of the colors. Therefore, an image is formed on the rotary drum 18 by repeating ejection and preliminary curing for all of the colors, and only then is the image transferred onto the recording paper 22.

As shown in FIG. 9, an inkjet recording apparatus 210 according to the present embodiment comprises: the printing unit 12 including the print head 12Y for the Y ink, the print head 12M for the M ink, the print head 12C for the C ink, and the print head 12K for the K ink, provided in accordance with each of the YMCK color inks; the ink storing and loading unit 14 which respectively stores radiation curing inks supplied to the print heads 12Y, 12M, 12C, and 12K; a preliminary curing device 116 disposed following the printing unit 12; a shielding plate 117, provided between the preliminary curing device 116 and printing unit 12, which ensures that the radiation emitted by the preliminary curing device 116 does not impinge on the printing unit 12; the rotary drum 18 serving as an intermediate transfer medium; the heater 20 which heats the rotary drum 18 from the interior; the conveyor belt 24 which conveys the recording paper 22 supplied from the paper supply unit (not shown); the transfer roller 26 which transfers an image formed on the rotary drum 18 onto the recording paper 22 by pressing the recording paper 22 against the rotary drum 18; the drive roller 28; the driven roller 30; the tension roller 32; the main curing device 34 disposed following the rotary drum 18; and the cleaning blade 36 which cleans the surface of the rotary drum 18 after an image has been transferred onto the recording paper 22.

In the present embodiment, a single preliminary curing device 116 is provided, and the wavelength region of the radiation for curing the inks are not different for each of the colors in contrasted with the first and second embodiments described above. However, in the present embodiment, the ink of one color is ejected and semi-cured by radiation with each rotation of the rotary drum 18. Therefore, the ink ejected first (the Y ink), for example, is emitted four times before transfer onto the recording paper 22. In addition, since the duration of heating increases steadily toward the ink ejected first, then a larger amount of solvent is evaporated from the ink ejected first.

In the present embodiment, excessive hardening and excessive evaporation of the ink ejected first is prevented by varying the curing sensitivity of each ink to radiation and the amount of solvent in each ink.

The print heads 12Y, 12M, 12C, and 12K for each ink color deposit inks of the respective colors onto the surface of the rotary drum 18 serving as an intermediate transfer medium, in the form of liquid droplets. As shown in FIG. 9, the print heads 12Y, 12M, 12C, and 12K are disposed in order of Y, M, C, and K from the upstream side of the rotation direction (indicated by an arrow in FIG. 9) of the rotary drum 18. As similar to the first embodiment, each of print heads 12Y, 12M, 12C, and 12K is a full-line head arranged substantially parallel to the axial direction of the rotary drum 18, having a length which is substantially equal to the entire length of the rotary drum 18.

The preliminary curing device 116 is disposed following the printing unit 12, which semi-cures the ink by emitting radiation onto the ink droplets of each color deposited on the surface of the rotary drum 18. The shielding plate 117 is disposed between the preliminary curing device 116 and printing unit 12. The shielding plate 117 is provided so as to ensure that the radiation emitted by the preliminary curing device 116 does not impinge on the print heads 12Y, 12M, 12C, and 12K of the printing unit 12, hereby hardening the ink in the nozzles (not shown in FIG. 9).

As similar to the first embodiment, the ink storing and loading unit 14 comprises ink tanks storing colored ink (radiation (ultraviolet) curing ink) corresponding to each of the print heads 12Y, 12M, 12C, and 12K. Each of the tanks communicates with the corresponding print head 12Y, 12M, 12C, or 12K via an ink supply pipe.

The constitution of the rotary drum 18 serving as the intermediate transfer medium is similar to that of the first embodiment shown in FIG. 1. The heater 20 is provided in the interior of the rotary drum 18, substantially parallel to the axial direction of the rotary drum 18, having a length which is substantially identical to the entire length of the rotary drum 18, which serves to heat the entire rotary drum 18 to a predetermined temperature. Therefore, the heater 20 heats and evaporates the ink droplets deposited onto the surface of the rotary drum 18.

The conveyor belt 24 transfers the image from the rotary drum 18 to the recording paper 22 by conveying the recording paper 22 which is supplied from the paper supply unit (not shown in FIG. 9), between the rotary drum 18 and transfer roller 26. Then, the recording paper 22 is conveyed to the paper output unit (not shown) by the conveyor belt 24. The conveyor belt 24 is a heat-resistant endless belt which is wrapped around the drive roller 28, driven roller 30, and tension roller 32.

The transfer roller 26 is a rotatable metallic roller as similar to the rotary drum 18, and the outer periphery of the transfer roller 26 is covered in rubber, for example. The transfer roller 26 is disposed parallel to the axial direction of the rotary drum 18 on the opposite side of the conveyor belt 24 to the rotary drum 18, having a substantially identical length to the entire length of the rotary drum 18.

In the present embodiment, when the rotary drum 18 performs the number of rotations corresponding to the number of colors, an image is formed, and only then is the image transferred onto the recording paper 22. Hence, during formation of the image on the surface of the rotary drum 18 prior to transfer, the transfer roller 26 is lowered so that a gap is provided between the transfer roller 26 and the rotary drum 18.

When a transfer image is formed after the rotary drum 18 performs a number of revolutions corresponding to the number of colors (four colors YMCK, in the example in FIG. 9), the transfer roller 26 is raised by a driving mechanism not shown in the drawing, and transfer is performed by pressing the conveyor belt 24 and recording paper 22 against the rotary drum 18. At this time, the transfer roller 26 is controlled by the print controller 80 (see FIG. 6) via the pressure varying device 108 in a similar manner to the first embodiment so that the recording paper 22 is pressed against the surface of the rotary drum 18 at a predetermined contact pressure.

The main curing device 34 is disposed above the conveyor belt 24 following the rotary drum 18. When the recording paper 22 is conveyed to the main curing device 34, the recording paper 22 is emitted with radiation (ultraviolet rays), and thus the image on the recording paper 22 is cured mainly and fixed.

The cleaning blade 36 is provided in front of the print heads 12Y, 12M, 12C, and 12K, which cleans the surface of the rotary drum 18 after transfer. The cleaning blade 36 is disposed rotatably about a spindle 36a, and during formation of a transfer image on the rotary drum 18 prior to transfer, the cleaning blade 36 is held in a position removed from the rotary drum 18 so that cleaning is not performed. The cleaning blade 36 is moved into contact with the rotary drum 18 only after the image has been transferred, and at this time the surface of the rotary drum 18 is cleaned in preparation for formation of the next transfer image.

As described above, in the present embodiment, the rotary drum 18 performs a single revolution for each color, and ink ejection and semi-curing through radiation are performed with every rotation. Accordingly, it is necessary that the radiation curing sensitivity and the amount of solvent are varied for each ink color so that the ink with the lowest sensitivity is ejected first (in other words, in rising order of the levels of sensitivity of the inks).

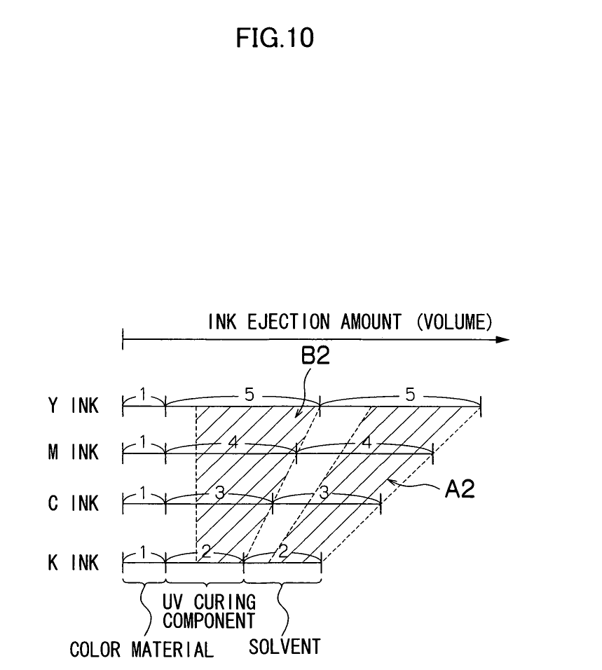

FIG. 10 shows the proportions of color material UV (radiation) curing component and solvent in the ink ejection amount (ejection volume) of each ink. Here, it is assumed that each ink is an aqueous UV curing ink.

In the present embodiment, the inks are also ejected during transfer in order of K-C-M-Y onto the recording paper 22 so that the lightest color forms the top layer. Therefore, when deposited onto the rotary drum 18, the inks are ejected in the order of Y-M-C-K onto the rotary drum 18.

Therefore, as shown in FIG. 10, the curing sensitivity to radiation (UV light) is set to be steadily lower toward the Y ink ejected first. There are no particular limitations on the method of varying the sensitivity, and various methods may be employed. In FIG. 10, the curing sensitivity is adjusted according to the liquid volume of the UV curing component, but the curing sensitivity may be adjusted by varying the liquid concentration of the UV curing component. In this case, the liquid amount of the UV curing component in FIG. 10 has the same volume in the ink of each color, and only the volume of the solvent differs among the inks of each color. For example, the degree of polymerization or the like may be varied. Furthermore, since the duration of heating on the rotary drum 18 increases steadily toward the ink ejected first, a larger amount of solvent may be evaporated. Therefore, the amount of solvent is also increased steadily toward the ink ejected first.

In FIG. 10, the ink ejection is performed in order of Y-M-C-K from the top in the drawing. The proportion (amount) of color material is the same “1” for each ink, but the proportions (amounts) of UV curing component and solvent increase steadily toward the ink ejected earlier. In FIG. 10, a region A2 indicated by diagonal lines denotes the proportion (amount) of evaporated solvent on the rotary drum 18, and a region B2 indicated by diagonal lines denotes the amount of UV curing on the rotary drum 18.

The period during which the ink is emitted with the radiation (UV light) and the period during which the ink is heated increase steadily toward the ink ejected earlier. Therefore, the amounts of UV curing component and solvent are set to increase steadily toward the ink ejected earlier so that the amounts of uncured UV curing component and non-evaporated solvent are the same in all of the inks when the transfer image is finally formed on the rotary drum 18, thereby increasing the ink ejection amount. For example, the total ejection amount of the Y ink ejected first is 120% greater than the ejection amount of the K ink ejected finally.

As described above, in the present embodiment, since the rotary drum 18 performs four rotations to form a single image on the recording paper 22 when YMCK four colors are used, the print speed is lower than that of the first embodiment described above. However, since only one preliminary curing device need be provided, it is possible to simplify the apparatus constitution. Other effects such as improving the image quality by reducing the relief effect of the image can be obtained as similar to the first and second embodiments.

Next, a fourth embodiment of the present invention will be described hereinafter.

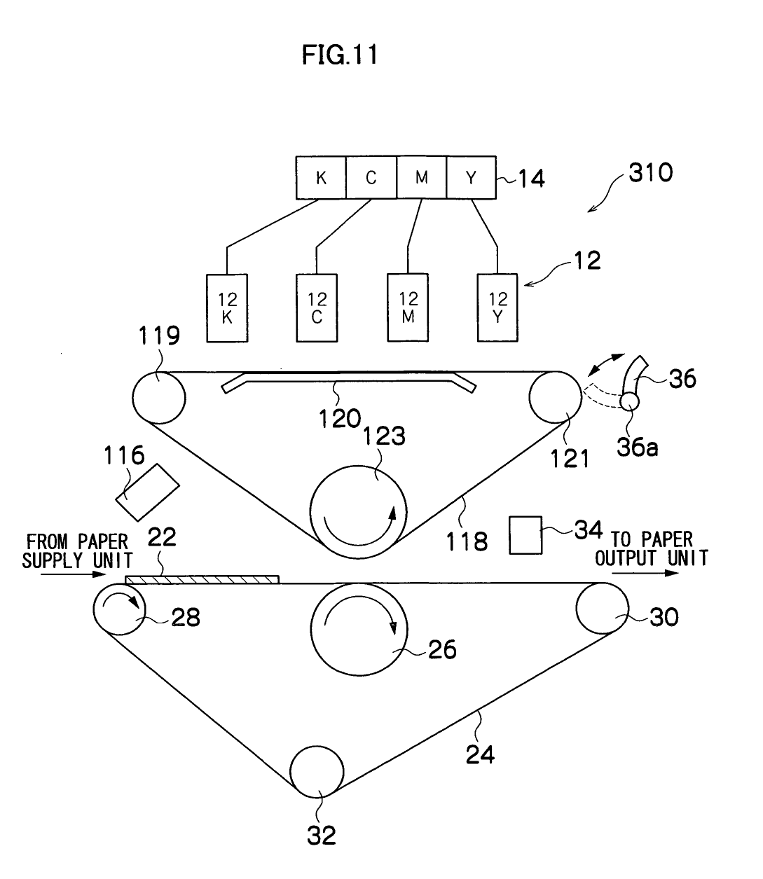

FIG. 11 shows the schematic constitution of an inkjet recording apparatus 310 according to the fourth embodiment.

The present embodiment is equivalent to the third embodiment described above with the intermediate transfer medium altered from a rotary drum 18 in FIG. 9 to an endless transfer belt 118 in FIG. 11. Therefore, the relationship of the fourth embodiment to the third embodiment is the same as the relationship of the second embodiment to the first embodiment.

As shown in FIG. 11, an inkjet recording apparatus 310 in the present embodiment comprises: the printing unit 12 including the print head 12Y for the Y ink, the print head 12M for the M ink, the print head 12C for the C ink, and the print head 12K for the K ink, provided in accordance with each of the YMCK color inks; the ink storing and loading unit 14 which stores radiation curing inks supplied to the print heads 12Y, 12M, 12C, and 12K, respectively; the preliminary curing device 116 disposed following the printing unit 12; the transfer belt 118 serving as an intermediate transfer medium; the heating plate 120 which heats the transfer belt 118 from the inside; the conveyor belt 24 which conveys the recording paper 22 supplied from the paper supply unit (not shown); the first and second transfer roller 123 and 26 which transfers an image formed on the transfer belt 118 to the recording paper 22 by pressing the recording paper 22 and transfer belt 118 together from either side; the drive roller 28 which moves the conveyor belt 24; the driven roller 30; the tension roller 32; the main curing device 34 disposed following the transfer belt 118; and the cleaning blade 36 which cleans the transfer belt 118 after an image has been transferred onto the recording paper 22.

As described above, the present embodiment differs from the third embodiment merely in that the endless transfer belt 118 is used as an intermediate transfer medium instead of the rotary drum. Therefore, the present embodiment is identical to the third embodiment in all other components. Incidentally, as shown in FIG. 11, the transfer belt 118 is wrapped around the rollers 119 and 121, and the preliminary curing device 116 is disposed on the lower side of the roller 119. Therefore, there is no particular need to provide a shielding plate to prevent radiation from impinging on the printing unit 12.

In the present embodiment as similar to the third embodiment, the transfer belt 118 (instead of the rotary drum) rotates in accordance with the number of colors, and ink ejection and semi-curing through radiation emission are performed upon each rotation of the transfer belt 118. Accordingly, for example, the radiation curing sensitivity and the amount of solvent are varied for each ink color so that the ink with the lowest sensitivity level is ejected first (in other words, in rising order of the levels of sensitivity of the inks), as shown in FIG. 10.

Consequently, in the present embodiment as similar to the third embodiment, the image quality can be improved by reducing the relief effect of the image.

In the third and fourth embodiments described above, only one preliminary curing device 16 or 116 is provided. When the YMCK inks are ejected onto the rotary drum 18 or the endless belt 118 in order from the ink with the lowest sensitivity level (in other words, in rising order of the levels of sensitivity of the inks) one color at one rotation of the rotary drum 18 or the endless belt 118, each of the inks deposited onto the rotary drum 18 or the endless belt 118 is semi-cured by radiation emitted from the preliminary curing device 16 or 116. Then, an image formed on the rotary drum 18 or the endless belt 118 (after four rotations) is transferred onto the recording paper 22. However, it is not necessarily that the ink is ejected and semi-cured one color at a time with each rotation. For example, inks having different sensitivity levels, such as those used in the third embodiment, may be employed in a similar constitution to that of the inkjet recording apparatus 10 of the first embodiment shown in FIG. 1. In this case, radiation curing ink is ejected from each or the print heads 12Y, 12M, 12C, and 12K in order from the ink with the lowest sensitivity level (in other words, in rising order of the levels of sensitivity of the inks). Then, each of the ejected inks is emitted with radiation from each of the corresponding preliminary curing devices 16Y, 16M, 16C, or 16K which are disposed following each of the print heads 12Y, 12M, 12C, and 12K.

At this time, each of the YMCK inks ejected from the respective print heads 12Y, 12M, 12C, and 12K have a different sensitivity level to each other. Accordingly, the preliminary curing devices 16Y, 16M, 16C, and 16K disposed respectively following each of the print heads 12Y, 12M, 12C, and 12K may vary the wavelength region as similar to the first embodiment, or may emit the same radiation without varying the wavelength region.

As described above, since the inks having different sensitivity levels of the third embodiment are used in a similar constitution to that of the first embodiment, a single image can be formed with a single revolution of the rotary drum 18. Needless to say, in this case also effects such as the prevention of color running and a reduction in the relief effect of the image can be obtained.

In addition, the inks having different sensitivity levels of the third embodiment may also be used in an apparatus constitution of the second embodiment.

The image forming apparatus according to the present invention has been described in detail above, but the present invention is not limited to the above examples, and may be subjected to various improvements and modifications within a scope that does not depart from the spirit of the present invention.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image forming apparatus, comprising:
an ejection head which ejects droplets of a radiation curing liquid;
an intermediate transfer medium on which an image is formed by the droplets ejected from the ejection head;
an evaporation device which evaporates the droplets deposited on the intermediate transfer medium;
a preliminary curing device which emits radiation onto the droplets deposited on the intermediate transfer medium in order to semi-cure the droplets so that the droplets do not blend with each other; and
a transfer device which presses a recording medium against the intermediate transfer medium so that the image formed on the intermediate transfer medium is transferred onto the recording medium, wherein:
the droplets deposited on the intermediate transfer medium are evaporated by the evaporation device; and
the evaporated droplets are semi-cured by the radiation emitted from the preliminary curing device, and then the image formed on the intermediate transfer medium is transferred onto the recording medium by the transfer device.

2. An image forming apparatus, comprising:
a plurality of ejection heads which respectively eject droplets of a plurality of radiation curing liquids corresponding to a plurality of colors;
an intermediate transfer medium on which an image is formed by the droplets ejected from the ejection heads;
an evaporation device which evaporates the droplets deposited on the intermediate transfer medium;
a plurality of preliminary curing devices which respectively emit radiation onto the droplets of the colors deposited on the intermediate transfer medium in order to semi-cure the droplets so that the droplets of the colors do not blend with each other; and
a transfer device which presses a recording medium against the intermediate transfer medium so that the image formed on the intermediate transfer medium is transferred onto the recording medium, wherein:
the intermediate transfer medium is at least one of a rotary drum and an endless belt;
the ejection heads are provided for the colors in a movement direction of the intermediate transfer medium;
each of the preliminary curing devices is disposed on a downstream side of each of the ejection heads in the movement direction of the intermediate transfer medium;
the droplets deposited on the intermediate transfer medium are evaporated by the evaporation device, and then are semi-cured by the radiation emitted from the preliminary curing devices; and
the radiation curing liquids of the colors are deposited onto the intermediate transfer medium so as to form the image on the intermediate transfer medium during one rotation of the intermediate transfer medium, and then the image formed on the intermediate transfer medium is transferred onto the recording medium so as to form the image on the recording medium.

3. The image forming apparatus as defined in claim 2, wherein:
the radiation curing liquids of the colors are cured by the radiation in different wavelength regions; and
each of the preliminary curing devices emits the radiation in each of the wavelength regions which cure each of the radiation curing liquids ejected from each of the ejection heads.

4. The image forming apparatus as defined in claim 2, wherein:
a solvent amount in the radiation curing liquid of the color ejected first is set to be larger than the solvent amount in the liquids of the colors that are ejected subsequently if the image is formed with the droplets of the colors having a same diameter.

5. The image forming apparatus as defined in claim 2, wherein:
the radiation curing liquids of the colors have different levels of sensitivity to the radiation from each other; and
the ejection heads are arranged in the movement direction of the intermediate transfer medium in rising order of the levels of sensitivity of the radiation curing liquids ejected from the ejection heads.

6. The image forming apparatus as defined in claim 2, wherein the colors include at least three colors of cyan, magenta, and yellow.

7. An image forming apparatus, comprising:
a plurality of ejection heads which respectively eject droplets of a plurality of radiation curing liquids corresponding to a plurality of colors;
an intermediate transfer medium on which an image is formed by the droplets ejected from the ejection heads;
an evaporation device which evaporates the droplets deposited on the intermediate transfer medium;
a single preliminary curing device which emits radiation onto the droplets of all of the colors deposited on the intermediate transfer medium in order to semi-cure the droplets so that the droplets of the colors do not blend with each other; and
a transfer device which presses a recording medium against the intermediate transfer medium so that the image formed on the intermediate transfer medium is transferred onto the recording medium, wherein:
the intermediate transfer medium is at least one of a rotary drum and an endless belt;
the ejection heads are arranged in the movement direction of the intermediate transfer medium in rising order of the levels of sensitivity of the radiation curing liquids ejected from the ejection heads;
the single preliminary curing device is provided on a downstream side of the ejection heads in the movement direction of the intermediate transfer medium;
the droplets deposited on the intermediate transfer medium are evaporated by the evaporation device;
each of the radiation curing liquids is deposited from each of the ejection heads onto the intermediate transfer medium one color at one rotation of the intermediate transfer medium, and is emitted with the radiation from the single preliminary curing device the one color at the one rotation of the intermediate transfer medium; and
the intermediate transfer medium is rotated at least a number of times corresponding to a number of a number of the colors so as to form the image on the intermediate transfer medium, and then the image is transferred onto the recording medium by the transfer device.

8. The image forming apparatus as defined in claim 7, wherein the colors include at least three colors of cyan, magenta, and yellow.
